(19) United States
(12) Patent Application Publication
(10) Pub. No.: US 2003/0177102 A1
(43) Pub. Date: Sep. 18, 2003

(54) System and method for biometric authorization for age verification

(76) Inventor: Timothy Robinson, Herndon, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/369,235

(22) Filed: Feb. 19, 2003

Related U.S. Application Data
(63) Continuation-in-part of application No. 10/251,305, filed on Sep. 20, 2002.
(60) Provisional application No. 60/324,229, filed on Sep. 21, 2001.

(51) Int. Cl. G06F 17/60

(52) U.S. Cl. 705/75

(57) ABSTRACT

The present invention is a system and method of biometric-based age verification for authorizing presenter access of age-restricted good or services between an age presenter and an age verifier. System presenters register at least one biometric identifier, at least one identification number, personal age-verifying data, and personal identity-verifying data. A presenter presents a biometric sample obtained from the presenter's person and the presenter's system ID number to conduct age verifications for purchase of or access to age-restricted goods or services. This data is used to authenticate the presenter's age and authorize access to purchase or obtain age-restricted goods or services by matching the presented transaction biometric with at least one registered biometric template and without the use of a man-made identity token.

### CROSS REFERENCE TO RELATED APPLICATIONS

This application is a continuation-in-part of application Ser. No. 10/251,305, filed Sep. 20, 2002, which claims domestic priority from provisional application No. 60/324,229, filed Sep. 21, 2001. The Ser. No. 10/251,305 application is incorporated by reference herein, in its entirety, for all purposes.

### FIELD OF THE INVENTION

This application relates generally to age verification. More particularly, the present invention relates to a tokenless system and method for age verification using a biometric and a system identification number (SID).

### BACKGROUND OF THE INVENTION

The U.S. Department of Health and Human Services (HHS) in their “1999 National Household Survey” reports underage tobacco and alcohol use is a persistent societal problem. At the time of the survey, an estimated 66.8 million Americans reported current use of a tobacco product, and 4.1 million, as reported by theantidrug.com, were between the ages of 12 and 17. Additionally, HHS estimated that 105 million Americans, 10.4 million of which were between the ages of 12 to 20, used alcohol at least once within the 30 day period preceding the survey.

As reported by the U.S. Department of Justice's “Guide to Conducting Alcohol Purchase Surveys,” various surveys conducted across the U.S. have found that underage individuals were able to buy alcohol in 50 to 97 percent of stores, bars, and restaurants where attempts were made.

Although the government enforces fines and license suspension penalties on establishments that sell age-restricted goods to underage individuals, increased availability of inexpensive technology used to construct fake identifications for underage individuals to present in order to obtain age restricted goods makes age verification more difficult. Instances of selling age-restricted goods to underage individuals also often results from careless employee verifications of a consumer's age before the consumer purchases age-restricted goods. Commonly, employees who are supposed to be verifying a consumer's age will not even look at the consumer's identification, and in systems that prompt employees to enter the consumer's birth date, employees often enter a fictitious birth date. Such careless age verification may go unnoticed by a store manager or owner. However, if authorities catch an employee selling age-restricted products to underage consumers, the manager or owner is often held responsible for the employee's actions in addition to the employee. Depending on state and federal laws, both the employee and merchant may suffer monetary penalties and/or the merchant may even have their license to sell age-restricted goods revoked as a result of their employee's careless behavior. In many states, merchants may lose their license to sell age-restricted goods for up to sixty days.

One of the main problems with the current system of age verification is that it relies too heavily on a token-based verification system. Currently, individuals seeking age verification present a state issued identification token for age verification purposes in an age-restricted transaction or access. However, such systems are easy prey to presenters bearing fake IDs or careless employees who lack a conscientious work attitude.

In addition to the age verification procedures described above, other age verification systems have been proposed that rely on tokens. Since they rely on tokens, they do not solve the problems associated with the token-based age verification systems described above. For further details, refer to U.S. Pat. No. 6,332,134 and U.S. Pat. No. 6,196,460.

What is needed is a tokenless age verification system that requires an individual seeking age verification to present biometric identification rather than token-based identification. Such a tokenless system would provide age verifiers with a more secure and accurate system for verifying age. Since age verification in such a system would be tied to an individual's biometric rather than a token, the chances are minimized that an individual can successfully present false age verification, or that a careless employee can bypass the system. Additionally, such a system would present a form of age verification that could not be lost, stolen, or fabricated. What would be quite useful would be a system and method that links an individual's biometric with age verifying information and allows the individual to verify their age at any participating point of verification by presenting a registered biometric and SID (System IDentification number).

### SUMMARY OF THE INVENTION

One aspect of the present invention is that it provides a reliable system and method that conducts age verification of individuals for access to age-restricted areas, goods, and services.

It is also an aspect of the current invention to offer verifiers (individuals verifying another individual's age) and presenters (individuals trying to verify their own age) a convenient, reliable, and secure way to conduct an age verification in an age-restricted transaction with the use of a biometric read (such as a fingerprint) and a system ID (SID) number entry and without the use of any age-verifying token(s).

It is another aspect of the invention to provide a system and method to help deter individuals from presenting fraudulent identification during an age-verification transaction by linking age verification to biometric identification and by monitoring verifier activity within the system.

It is also an object of the present invention to create a system that allows an individual to present age verifying and identity verifying documents once upon enrollment and then to use a SID and biometric sample to verify their age thereafter at participating devices in the system.

A system implementing the present invention uses at least one database that stores information concerning a plurality of age presenters (i.e., individuals seeking age verification). The system uses at least one point of verification (POV) terminal that has connections to necessary peripherals for biometric scanning and has communication lines for connection to the database where the presenter information is stored.

To register in the system, an individual presents at least one biometric sample, identity-verifying information, and age-verifying information. The biometric sample may be, for example and without limitation, a fingerprint, a retinal scan, a face geometric scan, or a voice print. The identity-verifying information may be, for example and without limitation, a name, a home address, a telephone number, or a government ID number and state of issue. The age-verifying information may be, for example and without limitation, age, date of birth, or a driver's license scan. The individual also registers with the system a system identification number (SID) that is used in conjunction with their biometric scan for age verification.

An individual who has already registered in the system may verify their age at any participating POV by entering the individual's SID and biometric sample. This information is sent to a database where it is used to find the individual's age verifying record. Once the age verifying record is found, the individual's age is evaluated to determine whether or not it is at or above the level pre-set for the particular verification. If the individual's age is at or above the pre-set level, the individual's age is verified, and the individual is granted access. This access may be used for (but is not limited to) purchasing age-restricted goods, accessing age-restricted areas, or purchasing age-restricted services.

These and other aspects of the present invention will become apparent to those skilled in the art by a review of the following detailed description. Although a number of salient features of the present invention have been described above, the detailed description that follows provides a more detailed exposition of additional features of the invention as it is embodied in various forms.

In this respect, before explaining at least one embodiment of the invention in detail, it is to be understood that the invention is not limited in its application to the details of construction and to the arrangements of the components set forth in the following description or illustrated drawings. The invention is capable of other embodiments and of being practiced and carried out in various ways. Also, it is to be understood that the phraseology and terminology employed herein are for the purposes of description and should not be regarded as limiting.

### BRIEF SUMMARY OF THE DRAWINGS

Additional objects and advantages of the present invention will be apparent in the following detailed description read in conjunction with the accompanying drawing figures.

FIG. 1 illustrates a block diagram overview of the general architecture of a system for age verification according to an embodiment of the present invention.

FIG. 2 illustrates a flowchart of a process for enrollment into an age verification system according to an embodiment of the present invention.

FIG. 3 illustrates a flowchart of a process for an age verification transaction using an age verification system according to an embodiment of the present invention.

FIG. 4 illustrates a flowchart of a process for age verification with remote biometric matching using an age verification system according to an embodiment of the present invention.

FIG. 5 illustrates a flowchart of a process for age verification with local biometric matching using an age verification system according to an embodiment of the present invention.

FIG. 6 illustrates a flowchart of a process for age verification with approval rules being set by the verifier using an age verification system according to an embodiment of the present invention.

### DETAILED DESCRIPTION OF THE INVENTION

As previously noted, the present invention encompasses a system and method for verifying an individual's age using a biometric sample and an identification number.

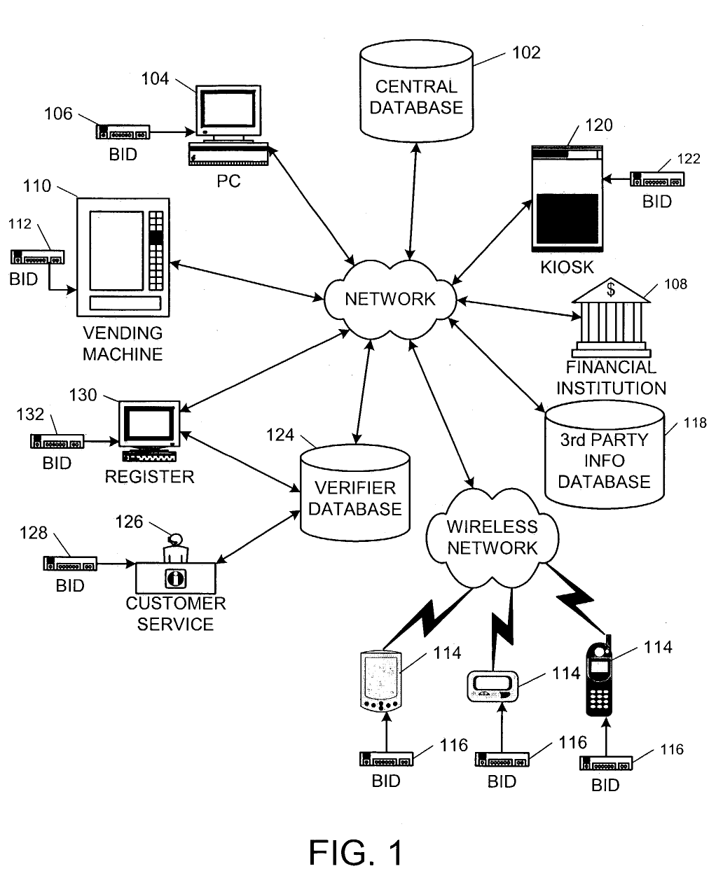

Referring to FIG. 1, a general architecture overview of a system for age verification using biometric and system ID matching is illustrated. The system includes a verifier database 124, wherein age verification records are stored, as well as information about authorized points of verification (POVs). The age verification records contain information related to individuals seeking age verification (that is, presenters). Various other records and databases may also be held in the verifier's database.

Alternatively (or redundantly), the central database 102 holds information related to presenters and authorized POVs. The central database 102 may further hold one or more databases that store various system data. In such an embodiment, age presenter data, verifier data, and other system data may be distributed across multiple databases within the central database 102.

Age verifying records hold presenter age verifying and identity verifying information, such as a presenter's age, date of birth, government ID number and state of issue, home address, or a telephone number; at least one biometric template; and at least one ID number (SID) that identifies the presenter within the system. A presenter may choose a SID from any of the previously listed personal identification numbers, provided the number is unique. They may select their own SID, provided the number is unique, or they may choose from among system-suggested ID numbers.

POV information comprises information useful in recognizing, identifying and/or authenticating a POV station for accessing the age-verification system. Such information may include, but is not limited to, address of the POV location, POV identification number, and POV manufacturer.

The system may be configured so that the central database 102 is connected to a network, such as, but not limited to, the Internet. This network comprises connections to at least one POV device, such as but not limited to a computer 104 having a connected or integrated biological identification device (BID) 106, a vending machine 110 having a connected or integrated BID 112, a wireless device 114 having a connected or integrated BID 116, a kiosk 120 having a connected or integrated BID 122, a verifier database 124 having a connected age-verification devices such as a presenter service computer 126 having a connected or integrated BID 128 and/or a transaction register 130 with connected or integrated BID 132. The transaction register 128 may be embodied so as to have a direct connection to the network through which it may communicate with the central database 102. However, such a direct connection is not strictly required in order to practice the present invention.

According to an alternate embodiment, the system also includes connections to one or more financial institution 108 and one or more third party information database 118. Such connections enable presenters to perform financial transactions with their age-verifying records. Structure and processes for effecting such financial transactions are disclosed in detail in co-pending utility application Ser. No. 10/251,305 filed on Sep. 20, 2002. By way of illustration and not as a limitation, the type of information held in the third party database(s) includes government, financial, public, and private information. Examples of third party databases that would be useful for implementing this alternate embodiment are TransUnion, Experian, and Equifax.

Presenters interested in enrolling in the age verification system further have the option to pre-enroll, that is provide a partial enrollment, by providing only a portion of enrollment information, for the age verification services via a computer 104, a vending machine 110, a wireless device 114, a kiosk 120, or a verifier device 126, 130. Pre-enrollment records are stored as partial records that cannot be used until the remainder of enrollment information is collected. Such partial records are marked pre-enrollment. Pre-enrollment records are stored in the central database 102 but may be accessed by any participating verifier for enrollment completion. According to one embodiment, pre-enrollment records are stored only in a verifier's database 124. Such an embodiment asks presenters to choose a verifier to send their pre-enrollment information to. According to an alternative embodiment, a pre-enrollment record may be stored in both the central database 102 and a verifier database 124.

Pre-enrollments may be conducted at system devices with or without a BID. If the presenter pre-enrolls at a device in the system that does not have an attached BID, they may finalize enrollment at any participating device with an attached or integrated BID by selecting an option on the device nominated as “finish enrollment.” The device then prompts the presenter to enter their pre-enrolled SID and present one or more designated biometrics for scanning. This information is sent to the central database to locate the presenter's partial system record. If a partial record matching the presenter's SID is found, the biometric sample entered is stored and the central database sends the presenter notice of enrollment.

Other forms of pre-enrollment may include registering with the age verification system's central database various presenters' information that is purchased or acquired database information. By way of illustration and not as a limitation, the central database operator purchases driver's license data from a state or government database and uses that information during presenter pre-enrollment, wherein the information is checked when the presenter pre-enrolls, is checked during enrollment finalization wherein the presenter is seeking to complete their enrollment into the system, or is checked during a complete enrollment. Said information could be easily entered into the central database so that when a presenter whose information was recorded in one of those databases wants to pre-enroll or enroll in the system of the invention, some or all of that information contained within said purchased or acquired database would already be available within the system. The already stored information would not need to be entered at the time of enrollment, thus saving time for the presenter during enrollment.

Age verifications are conducted within the system through a number of devices including but not limited to verifier devices connected to a verifier database 124, such as a register 130 or presenter service computer 126. In another embodiment, the system is also configured to conduct age verifications through devices such a vending machine 110 with an attached BID 112, a kiosk 120 with an attached BID 122, a PC 104 with an attached BID 106, and a wireless device 114 with an attached BID 116.

Presenters are free to manage their system records through a record management function that allows individuals to update personal information registered in their system record. These changes may be conducted at any of the following: a computer 104 with a BID 106, any participating vending machine 110 with a BID 112, a wireless device 114 with a BID 116, a participating kiosk 120 with a BID 122, or any participating verifier's device 126 with a BID 128, or a register 130 with a BID 132.

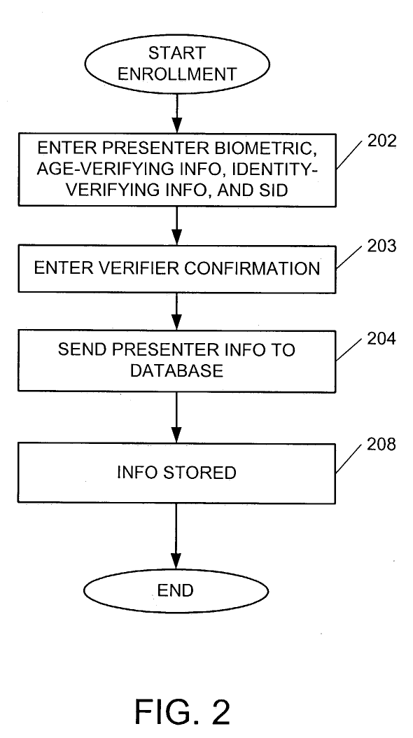

Referring to FIG. 2, a flowchart of an enrollment process according to an embodiment of the present invention is illustrated. The presenter is prompted to provide identity and age verifying information, a SID, and at least one biometric sample 202. According to an optional embodiment, the presenter also provides information on one or more financial accounts to link to the age verifying record for which they are enrolling. This financial account would enable the presenter, once enrolled in the system, to authorize payment for purchases through biometric authorization.

By way of illustration and not as a limitation, one way of presenting the age verification information during enrollment is for driver's license data to simply be read from a magnetic stripe or bar code on the driver's license, from which date of birth information is pulled and used to calculate the presenter's age. Examples of suitable identity-verifying information are: a government ID number and state of issue, social security number, address, phone number, digital scans of information documents presented for identification, and other personal information about the enrolling presenter. This information may be card-swiped, scanned, hand-keyed, or entered by another means by the presenter or verifier. Optionally, identity documents such as a driver's license or identification card are digitally imaged and stored in the respective presenter's age verifying record. Digitally imaging identity documents would provide the system of the invention a security feature that would enable verifiers to view digital images of the identity documents presented for initial age verification. Such a feature would also enable authorized individuals (such as verifiers and law enforcement) who challenge an age verification to view the identifying documents the presenter presented upon enrollment into the system.

An additional feature of the present invention is the availability of further verifying age verification information, identity verification information, or biometric information stored with at least one participating third party database. Further verifying age and/or identity information adds to the system's security but is not strictly required to practice the present invention. By way of illustration and not as a limitation, retrieving further verifying information from a third party database includes the device accessing the third party database for out-of-wallet information, such as where the presenter went to college, asking the presenter questions related to that out-of-wallet information, such as “which college did you attend: a, b, or c?” Such information is commonly stored in credit databases as a result of student loan information.

Yet another embodiment of the invention comprises checking presenter age verification information against presenter age verification information that may already be recorded in the central database as a result of the central database owner obtaining or purchasing information from private, public, or government databases. Examples of such information include, but are not limited to, driver's license data, employment data, and biometric data. All information obtained or purchased from such databases by the central database owner may be utilized for verification or confirmation of presenter information.

The presenter's biometric sample is entered via a biometric scanner. This sample is then translated to and stored in template form. Template forms of scanned biometrics are generally used for biometric comparisons. In an additional embodiment, the digital scan of the biometric is itself stored in the invention's central database. Such an embodiment that also stores the biometric digital scan is useful for reasons such as, but without limitation, biometric matching purposes, security procedures (in the case of an individual attempting to fraudulently access the system), or information protection in the event database information is lost or templates need to be re-constructed due to hardware revisions.

The system may optionally be configured to allow a presenter to register more than one type of biometric sample or two or more of the same type of biometric during enrollment. For example, the invention's system may be configured to accept a fingerprint biometric along with a face scan biometric, or the system may be configured to allow the presenter to register finger scans from more than one finger. Storing a biometric template in the presenter's system record that includes data from more than one biometric sample type enables that presenter the convenience of presenting any one of the presenter's previously scanned biometrics for age verification, record access authorization, and/or funds transfer.

The SID is a number used to help identify registered individuals in the invention's system. This SID is not equivalent to a PIN (Personal Identification Number) used for financial ATM and debit transactions. Rather, the SID simplifies the verification of the biometric sample. The SID may be a unique number (a number with no chance of being honestly duplicated, e.g. social security number), reasonably unique number (a number with a statistically small chance of being duplicated, e.g. phone number), or a non-unique number (a number with a large chance of being duplicated). While a SID comprising a unique number will inherently provide more security, the present invention is not so limited.

According to another alternative embodiment, a secondary ID number is utilized in the event that an individual does not remember the SID. In this embodiment, the secondary ID number is any number a registered individual registered during enrollment, such as, but not limited to, a home phone number, work phone number, social security number, or driver's license number.

According to yet another alternative embodiment, no SID number is used for verification of the presenter's age or identity. This is enabled when the biometric reading device conducts a reliably accurate read of a presenter's biometric that contains only a small fraction of error or no error. Additionally, an embodiment that allows a presenter to enter only their biometric might store presenter biometric sample and SID information on a device or database locally networked to the device. The device could then search the locally stored biometric templates for a match to the presenter's transaction biometric. Once a match was found, the transaction would proceed from that step, either accessing the system's central database or the local database depending on the configuration of the system. In this embodiment, the device or local database would store biometric sample and SID information for a set number of customers or would store such information for a set number of frequent customers.

In an additional embodiment, presenter personal information may be obtained for initial age verification and not stored in the presenter's age verifying record. Such an embodiment would provide presenters with a form of anonymous identification since the system would still recognize the presenter via biometric scan and SID but the biometric and SID would only be linked to age-related information and not personal information, such as home address and phone number.

In a further embodiment, if the presenter chooses to link a financial account with their age verifying record, financial account information is entered via magnetic stripe read, hand keying, or another input method. Checking record information is entered by a magnetic ink character recognition (MICR) read, an optical character recognition (OCR) read, hand keying, or entered by another method of input. The method of information input is also recorded for each enrollment. In an alternate embodiment, the system is configured to take a digital image of the monetary-representative token the presenter normally uses to access the presented financial account and store this digital scan in the presenter's system record. In an additional embodiment, the history of the presenter's financial transactions may be stored in their system record. Storing this information would enable the system to recognize the presenter's buying patterns for marketing purposes. By way of illustration and not as a limitation, it is feasible that biometrically authorized financial transactions be conducted in a system and method such as that described in utility application Ser. No. 10/251,305, filed Sep. 20, 2002, having common inventorship with this application.

Continuing with the enrollment process, the verifier enters confirmation into the system that they have reviewed and accepted the presenter's enrollment information 203. To aid the security of the system, this confirmation is entered into the system by a verifier entering verifier identifying data, such as a biometric and/or ID number. Such verification allows the system to track verifier behavior within the system, so that if a particular verifier falls under suspicion of fraudulent verification activity, each enrollment that verifier has confirmed may be evaluated. A presenter can then have their records re-verified in the event their records were previously verified by a verifier who is now under suspicion. Additionally, such verifier confirmation helps discourage presenters from attempting to enroll in the system with false identification and helps discourage dishonest verifiers from confirming fraudulent presenter information. However, the present invention is not so limited. The present invention may alternatively be configured such that the verifier simply presses a designated confirmation key or button on the device.

After presenter data and verifier confirmation is entered, all data entered is transmitted to the verifier database 204 where it is stored 208. In an additional embodiment, other information may also be transmitted to the verifier database, such as but without limitation, the TID of the device the presenter is using to enroll into the system, the time of day, and the device location.

In an additional embodiment, verification information (all information entered into the system such as presenter enrollment information, verifier information, or age verification transaction information) is transmitted and stored in the system's central database. Such a system is referred to as an “open” system. An open system allows presenters to verify their age at any verifier registered in the system regardless of where they enrolled in the system because open systems comprise sharing presenter information stored in the central database with all registered verifiers. Open systems may also allow registered verifiers to choose whether or not to accept open sharing of verification information stored in the central database by setting rules that age verifying records must meet before a verification of that record and the information contained therein is verified. By way of illustration and not as a limitation, such verifier rules might include declining previous verifications of presenters in the system who enrolled at other specific verifiers, declining verifications of presenters who enrolled in the system over a year previous to the transaction, or declining verifications of presenters who have not verified their age at any verifier in a set amount of time.

Another embodiment of the system stores verification information only in the verifier database or verifier system wherein a presenter enrolls. This is referred to as a “closed” system because presenters enrolled in one verifier's database must enroll in each additional verifier database wherein they would like to verify their age with the system. Verification information is not shared among verifiers in a closed system, nor is verification information shared with the central database. Verifier databases in closed systems may query other databases, such as the central database or a third party database, for presenter verifications. However, all verification information that is entered into a particular verifier database is stored in that database. In an alternate embodiment of the closed system, information stored on a verifier database is additionally stored on the central database. Such an embodiment is useful for a reason such as, but without limitation, information protection in the event database information is lost.

In yet a further embodiment of the present invention, verification information is stored in select multiple verifier databases. In this embodiment, a system of verifiers will have chosen whether or not to share system information with the invention's central database. Such a system is referred to as a “multi-verifier” system. This system allows a chain of verifiers owned by the same entity or linked in some other manner to share verification information obtained at one or more of the linked locations amongst themselves without sharing that information with all other or non-designated other verifiers registered in the system. Verification information in a multi-verifier system is stored in either the central database or one or more of the select verifier databases in the verifier system. Information in such a system may be shared between verifier databases and the central database freely or sharing may be monitored by rules set in the verifier databases, central database, or both. By way of illustration and not as a limitation, one verifier might only want to share verification information with one of five verifiers in a multi-verifier system or all verifiers might not want to send or store verification transaction information in the central database.

In an additional embodiment of the present invention, POV devices monitored by automated verifiers may also be used for enrollment and age-verification. By way of illustration and not as a limitation, devices such as a vending machine 110, a PC 104, a kiosk 120, or a wireless device 114 are configured as automated POVs, requiring no human verifier present during system enrollments or system age verifications. For security and accuracy purposes, the system would optionally have presenters enrolling at an automated POV to enter their personal and age verifying information into the system via MAG stripe read, bar code read, OCR read, or digital image read from a government or state identification document, such as a driver's license or ID card. However, the present invention is not so limited. Additionally, presenters enrolling or conducting an age verification transaction at an automated POV may be monitored by the operating database via digital video.

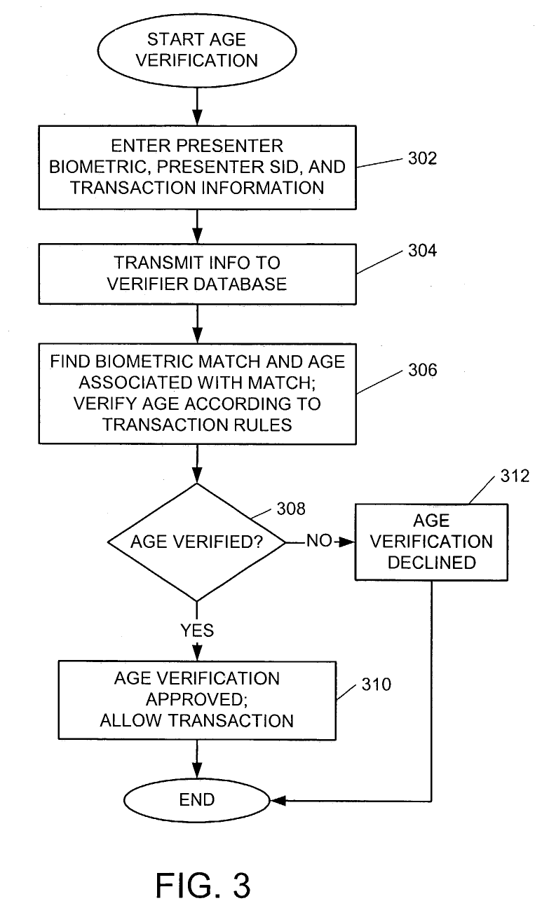

Referring to FIG. 3, a flowchart of an age verification transaction according to an embodiment of the present invention is illustrated. The presenter enters their SID and their biometric sample (herein referred to as the “transaction biometric”) and transaction information is entered 302. For example (and not as a limitation), transaction information sent to the database includes a rule code(s) mapped to the age-restricted action(s) for which the presenter has requested access. Such a code(s) indicates the presenter's requested access, which in turn indicates the rule(s) by which the presenter's age is evaluated. In an additional embodiment, such a rule(s) includes determining the presenter's allowance to access age-restricted goods/services with different age-restrictions. In such a system, it is possible that a presenter might be verified to access goods/services in one age-restricted group and not in another, even though the presenter requested to access goods/services from both groups. For example, a 19 year old presenter desiring to purchase items from both a group restricted to 18 and older presenters and a group restricted to 21 and older presenters would be verified to access the 18 and older goods/services but would be declined access to the 21 and older goods/services. Additional transaction information may also be sent to the verifier database such as terminal ID and time.

Continuing with the transaction, the presenter SID, presenter biometric, and transaction information are sent to the verifier database 304. The presenter's age verification record is found 306. The transaction biometric and the registered biometric data of the selected record are compared, and if the transaction biometric and stored biometric data match, the linked presenter age is evaluated according to a rule(s) linked to the transaction information sent to the database 306.

In an alternative embodiment, the transaction information sent to the database does not contain a code indicating the presenter's requested age-restricted access(es). In a closed system of such an embodiment, it is assumed that the verifier only offers access to age-restricted goods/services restricted to the same age group.

If the presenter's age is verified 308, the presenter's access to purchasing age-restricted goods and/or services or accessing an age restricted area is approved 310. In an additional embodiment, the presenter is automatically notified of the transaction approval. If for some reason the age verification is declined 312, or part of the age verification is declined, the presenter is notified.

Once an approval or decline has been made, the local device optionally informs the presenter of their age verification results via digital display or printed receipt. The system is also optionally configured to print or display to the presenter a reason that their age verification was declined and a phone number to the invention's service center to call for further explanation.

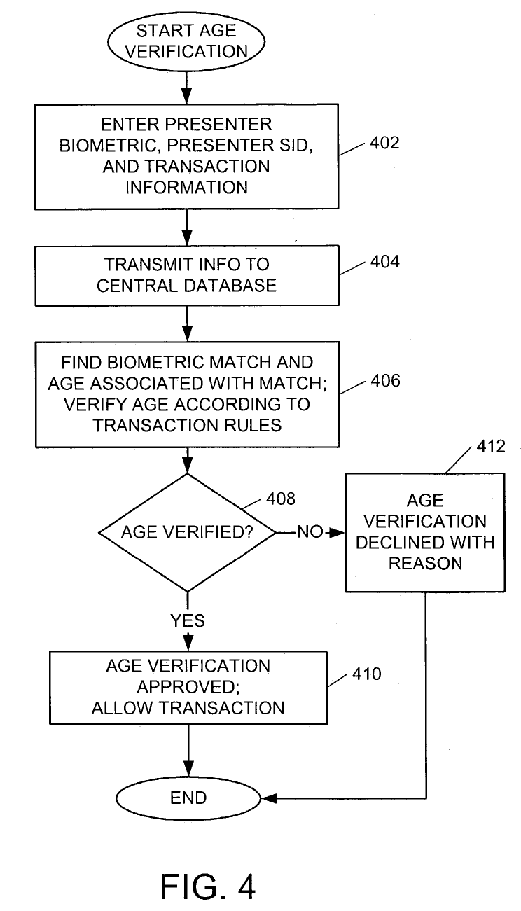

Referring to FIG. 4, a flowchart of an age verification transaction according to an embodiment of the present invention is illustrated. The presenter enters their SID and their transaction biometric and transaction information is entered 402. This information is sent to the central database 404. Additional transaction information may also be sent to the central database such as transaction type, transaction reference number, terminal ID, and time. The presenter's age verification record is found 406. The transaction biometric and the registered biometric data of the selected record are compared 406. If the transaction biometric and stored biometric data match, the linked presenter age is evaluated according to rules, also known as “transaction rules,” linked to the transaction information received 406. The presenter age is then verified according to rules 408, and the presenter's access to purchasing age-restricted goods and/or services or accessing an age restricted area is approved 410. In an additional, optional embodiment, the presenter is automatically notified of the approval. If for some reason the age verification is declined 412, or part of the age verification is declined, the presenter is notified.

Once an approval or decline has been made, the local device optionally informs the presenter of their age verification results via digital display or printed receipt. The system may also be optionally configured to print or display to the presenter a reason that their age verification was declined and a phone number to the invention's service center to call for further explanation.

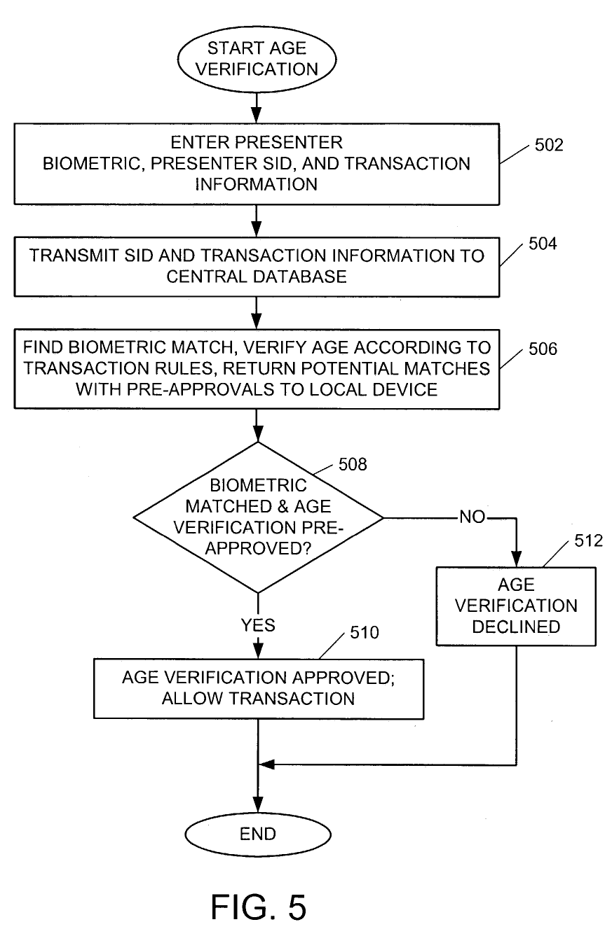

Referring to FIG. 5, a flowchart of an age verification transaction with local biometric matching according to an embodiment of the present invention is illustrated. Local biometric matching refers to the transaction biometric and registered biometric matching process taking place at a device or database in the local network of the verifier system wherein the age verification is requested. The presenter enters their SID and their transaction biometric and transaction information is entered 502. The presenter's SID and the transaction information are sent to the central database 504. Additional transaction information may also be sent to the system's central database such as transaction type, transaction reference number, device ID, and time. Once the presenter's age verifying record is found in the central database, the biometric data stored therein is pulled and the presenter age associated with it is evaluated according to rules linked to the transaction information that was sent to the database to determine whether the age verification will be approved or declined 506. If the age associated with the pulled biometric data is at or above the pre-set level for the age verification according to the rules, the biometric data that is sent back to the local device for matching is flagged to indicate that the age verification is pre-approved. However, if the age associated with the pulled biometric data is not at or above the pre-set level for age verification according to the rules, the biometric data sent to the local device will not be flagged, which will indicate to the device that the age verification is pre-declined. Additionally, if the transaction information initially sent to the central database includes more than one rule code, which potentially indicates to the system that the presenter is attempting to access various goods/services restricted by different age restriction rules, the ages linked to the potentially matching biometrics are pre-approved/pre-declined for each rule code. Each rule code is either flagged or not flagged, indicating to the local device pre-approval/pre-decline for each age-restricted access the presenter has requested, and returned to the device with their corresponding potentially matching biometric data.

In an additional embodiment, the age-restricted rules are optionally held at a database locally networked to the biometric device. In this embodiment, the central database might simply return the potentially matching biometric templates and their associated ages to the device. The device would then determine whether or not the presenter meets age-restricted rules by evaluating the age related to the biometric template that matches the transaction biometric provided by the presenter.

With continued reference to FIG. 5, the potentially matching biometric data and its pre-approval/pre-decline indication are returned to the device 506, where the biometric data is compared to the transaction biometric temporarily held at the local device 508. If a pre-approval indication was returned to the device, the age verification is approved 510. Once a pre-approval indication is associated with potentially matching biometric data, if that biometric data matches transaction biometric information, the age verification is automatically approved.

Once an approval or decline has been made, the local device optionally informs the presenter of their age verification results via digital display or printed receipt. The system may also be optionally configured to print or display to the presenter a reason that their age verification was declined and a phone number to the invention's service center to call for further explanation.

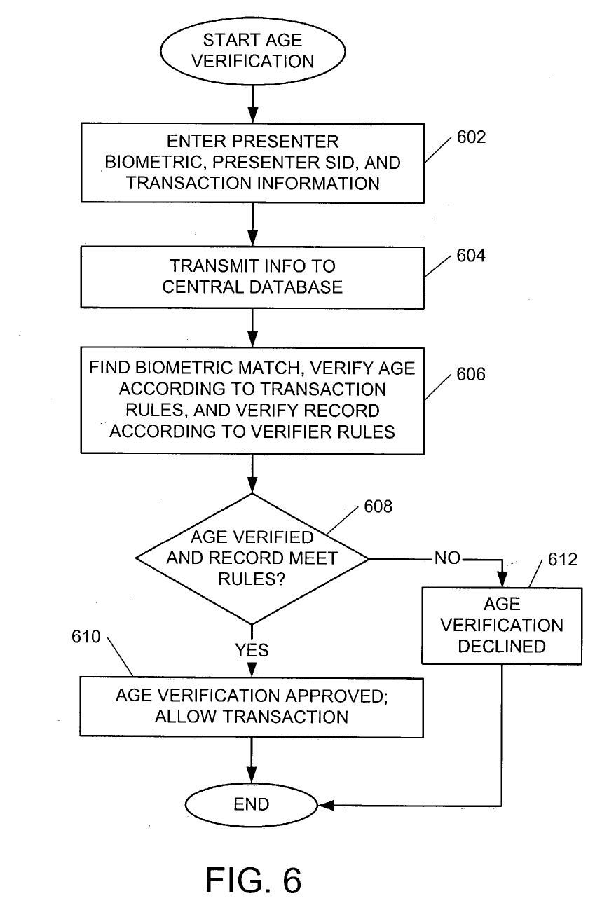

Referring to FIG. 6, a flowchart of an age verification transaction with verifier approval rules according to an embodiment of the present invention is illustrated. Verifier approval rules refer to rules a verifier or verifier system sets within the central database or verifier database that monitors presenter age verifications based upon certain criteria. By way of illustration and not as a limitation, such criteria includes evaluating where the presenter enrolled in the system, the identity of the verifier that enrolled the presenter into the system, when the presenter enrolled, how often the presenter uses their age verifying record, and/or how many times the presenter's age has been verified. For example, a presenter enrolls in the system at convenience store A. In an open system, the presenter should be able to verify their age at any verifier location in the system. However, convenience store B may not wish to trust an initial age verification conducted by convenience store A. Therefore, convenience store B would set rules that would decline age verifications of presenters who were initially verified at convenience store A. In such a system, convenience store B might offer to re-verify the presenter for future use of the system in their store.

Continuing with the verification process, the presenter enters their SID and transaction biometric and transaction information is entered 602. The presenter's SID, transaction biometric, and transaction information is sent to the central database 604. Additional transaction information may also be sent to the system's central database such as transaction type, transaction reference number, device ID, and time. Once the presenter's age verifying record is found in the central database, the biometric data stored therein is compared to the transaction biometric, the presenter age associated with it is evaluated according to rules linked to the transaction information the database received from the device, and if the age meets rules, the age verifying record is evaluated according to the verifier set rules 606. If the transaction biometric and stored biometric data match, the linked presenter age is acceptable according to transaction linked rules, and the age verifying record meets verifier set rules, the presenter's age is verified 608, and the presenter's access to purchasing age-restricted goods/services or accessing an age restricted area is approved 610. If for some reason the age verification is declined 612, or part of the age verification is declined, the presenter is notified.

Once an approval or decline has been made, the local device optionally informs the presenter of their age verification results via digital display or printed receipt. The system may also be optionally configured to print or display to the presenter a reason that their age verification was declined and a phone number to the invention's service center to call for further explanation. Additionally, if the presenter was declined age verification because their record did not meet pre-set rules, the presenter may be given instructions on how to meet these rules.

In an additional embodiment, open system age verification transactions regulated by verifier set rules, as illustrated in FIG. 6, are configured to match biometrics at the verifier device, as illustrated in FIG. 5. In such an embodiment, verifier rules would be stored in the central database and the pre-approval/pre-decline check would include verifying the chosen records according to those stored verifier set rules. Various additional embodiments and methods of the system are described as follows.

In an alternate embodiment of the invention, the system comprises utilizing an identification system wherein presenter records are associated with personal identifying information and a score which indicates the reliability of the information stored in the record and verifications performed with the record. This embodiment allows a presenter to verify their identity and age in one system access. Additionally, this embodiment also provides a presenter record score that is useful to determine the degree of reliability of the presenter's identity and/or age verification. This feature also allows the system to monitor the reliability of verifiers by requiring verifiers to identify themselves during supervision of an age verification transaction. This feature is useful to track the reliability of verifier actions within the system.

In another alternate embodiment, verifiers set the rules of age verification on goods and services which are not regulated by the government. For example, a verifier located at a movie theater would set various rules of age verification for purchase of age-related discount movie tickets or tickets to movies rated for a specific age. These rules are set in the verifier's local database and/or the central database of the invention, depending on whether the embodiment of the invention's system is open, semi-open, or closed.

An additional embodiment of the invention encrypts information transferred between two points in the system. For purposes of example and without limitation, information is encrypted at one point and sent across a non-secure connection between the points or not encrypted at a point of communication but sent to the other point of communication across a secure connection. Encryption and decryption of said messages may be monitored by services provided by a company such as VeriSign, Inc. As an added level of security, one alternate embodiment encrypts even information internal to a terminal and which is never transmitted in a communication. This prevents retrieval of sensitive information (e.g., data corresponding to a biometric scan) from a stolen terminal.

A hybrid embodiment of the invention enables presenters to verifying their age, verifying their identity, and/or paying for purchases with biometric authorization at various types of automated POV and POS stations. By way of illustration and not a limitation, such stations include linked or networked vending machines and linked or networked kiosks.

An additional feature of the present invention is giving an individual enrolling in a system according to an embodiment of the invention the ability to register a password that in conjunction with their system ID # would allow them to perform record maintenance of their system record over the Internet from a device without a BID.

Another embodiment of the invention includes the verifier and central databases providing presenters with system ID suggestions if their entered system ID is already registered within the system. These suggested IDs are preferably (but not necessarily) selected from system IDs that are not already registered in the system but are similar to the system ID the presenter originally entered.

An additional feature of the system allows direct transition from an enrollment into a POV or POS transaction without starting a new transaction. This would allow a presenter to enroll into the system just before they verify their age or purchase an item without having to reenter their biometric and SID.

A hybrid feature that is a useful option for use with any or all of the disclosed enrollment and identification methods is to print a paper receipt of the system activity performed during the system access. Information included on this receipt would be any information including but not limited to the transaction type, date, transaction number, record used, the system's customer service phone number, instructions on how to contact the system's customer service, or other transaction information.

It is also an alternate embodiment of the present invention to provide verifiers with presenter and verifier profile reports in case of suspected fraudulent activity. These reports are customizable to display select information from a presenter's age verifying record history or record.

According to another hybrid embodiment, the system is configured to send a POV's TID along with transaction information for presenter security purposes. If the TID is not registered with the central or verifier database, the presenter's information is not processed. Optionally, the POV display gives the presenter a system customer service number to call and a transaction code to reference during the call, so they may find out why the transaction was declined.

An age verification system using biometric identification and a system ID number has been illustrated. It will be appreciated by those skilled in the art that the systems and methods of the present invention can be used to perform more secure and reliable age verifications, and in addition, allows presenters to verify their identity and pay for merchandise with the same biometric used to verify their age. It is anticipated that the present invention will especially find utility in preventing underage individuals from accessing age-restricted goods. Although the age-restricted goods and services referred to in the invention's description are primarily tobacco and/or alcohol related, the system is not limited to verifying age for access to these specific age-restricted goods and services. Age-restricted goods and services are additionally those designated by the verifier. It will thus be appreciated by those skilled in the art that other variations of the present invention will be possible without departing from the scope of the invention as described.

What is claimed is:

1. A method of using a transaction system to provide approval of an age-restricted transaction between an age presenter and an age verifier, the transaction system having at least one database that has stored therein a biometric record associated with the age presenter via an age presenter identification code, and at least one age verification station configured to access the at least one database, and wherein the at least one database is adapted to apply transaction rules, wherein the method comprises:
receiving, at the age verification station, a biometric sample proffered by the age presenter via a biometric identification device;
receiving, at the age verification station, an identification code proffered by the age presenter;
receiving, at the age verification station, transaction information;
sending the biometric sample proffered by the age presenter from the age verification station to the at least one database;
sending the identification code proffered by the age presenter from the age verification station to the at least one database;
sending transaction information from the age verification station to the at least one database;
comparing, at the at least one database, the proffered identification code to age presenter identification codes stored in the at least one database;
making a first determination, at the at least one database, whether the proffered identification code matches an age presenter code stored in the at least one database;
in the event the proffered identification code matches an age presenter code stored in the at least one database, making a second determination whether the proffered biometric sample matches an age presenter biometric record stored in the at least one database;
in the event the proffered biometric sample matches an age presenter biometric template record in the at least one database, making a third determination whether the age information mapped to said biometric record meets the transaction rules; in the event the age information mapped to said biometric record meets the transaction rules, approving the transaction at the at least one database; and
receiving, at the age verification station, confirmation of the transaction approval.

2. The method of using a transaction system as claimed in claim 1, wherein the age presenter identification code comprises one or more of: a unique number, a reasonably unique number, and a non unique number.

3. The method of using a transaction system as claimed in claim 1, wherein the biometric sample comprises one or more of: a fingerprint scan, an iris scan, a facial scan, a voice scan, a retinal scan, a hand architecture scan, a vein pattern scan, a signature sample, and a DNA sample.

4. The method of using a transaction system as claimed in claim 1, wherein transaction data is encrypted and the communications between the age verification station and the at least one database are encrypted.

5. The method of using a transaction system as claimed in claim 1, wherein the transaction information comprises at least one alphanumeric code indicating in at least one database the transaction rules to apply to the transaction.

6. The method of using a transaction system as claimed in claim 5, wherein transaction information further comprises one or more of: the terminal identification number associated with an age verification station, the age verification station location, and the time of the transaction.

7. The method of using a transaction system as claimed in claim 1, wherein the age approval station is located at a location selected from the group consisting of: a verifier, a kiosk, an ATM, a telephone, a self-checkout POS register station, an automated cash register, a computer, a wireless device, and a vending machine.

8. The method of using a transaction system as claimed in claim 1, wherein system user information is stored in more than one database.

9. The method of using a transaction system as claimed in claim 8, wherein transaction information is compared to information stored in more than one database.

10. The method of using a transaction system as claimed in claim 1, wherein the age-restricted transaction comprises a financial transaction.

11. The method of using a transaction system as claimed in claim 10, wherein financial transaction settlement is conducted via a financial transaction system comprising biometric authentication of payors.

12. A method of using a transaction system to provide approval of an age-restricted transaction between an age presenter and an age verifier, the transaction system having a central database that has stored therein a biometric record associated with the age presenter via an age presenter identification code, the central database being adapted to apply transaction rules, and at least one age verification station configured to access the central database, wherein the method comprises:
receiving, at the age verification station, a biometric sample proffered by the age presenter via a biometric identification device;
receiving, at the age verification station, an identification code proffered by the age presenter;
receiving, at the age verification station, transaction information;
sending the biometric sample proffered by the age presenter from the age verification station to the central database;
sending the identification code proffered by the age presenter from the age verification station to the central database;
sending the transaction information from the age verification station to the central database;
comparing, at the central database, the proffered identification code to age presenter identification codes stored in the central database;
making, at the central database, a first determination whether the proffered identification code matches an age presenter code stored in the central database;
in the event the proffered identification code matches an age presenter code stored in the central database, making a second determination whether the proffered biometric sample matches an age presenter biometric record stored in the central database;
in the event the proffered biometric sample matches an age presenter biometric record stored in the central database, making a third determination whether the age information mapped to the biometric record meets transaction rules;
in the event the age information mapped to the biometric record meets transaction rules, approving, at the central database, the transaction; and
receiving, at the age verification station, confirmation of the transaction approval.

13. The method of using a transaction system as claimed in claim 12, wherein the age presenter identification code comprises one or more of: a unique number, a reasonably unique number, and a non unique number.

14. The method of using a transaction system as claimed in claim 12, wherein the biometric sample comprises one or more: a fingerprint, an iris scan, a facial scan, a voice scan, a retinal scan, a hand architecture scan, a vein pattern scan, a signature sample, and a DNA sample.

15. The method of using a transaction system as claimed in claim 12, wherein transaction data is encrypted and the communications between the age verification station and the central database are encrypted.

16. The method of using a transaction system as claimed in claim 12, wherein the transaction information comprises at least one alphanumeric code indicating at the central database the transaction rules to apply to the transaction.

17. The method of using a transaction system as claimed in claim 16, wherein transaction information further comprises one or more of: the terminal identification number associated with an age verification station, the age verification station location, and the time of the transaction.

18. The method of using a transaction system as claimed in claim 12, wherein the age verification station is located at a location selected from the group consisting of: a verifier, a kiosk, an ATM, a telephone, a self-checkout POS register station, an automated cash register, a computer, a wireless device, and a vending machine.

19. The method of using a transaction system as claimed in claim 12, wherein the age-restricted transaction comprises a financial transaction.

20. The method of using a transaction system as claimed in claim 19, wherein financial transaction settlement is conducted via a financial transaction system comprising biometric authentication of payors.

21. The method of using a transaction system as claimed in claim 12, wherein system user information is stored in more than one database.

22. The method of using a transaction system as claimed in claim 21, wherein transaction information is compared to information stored in more than one database.

23. A method of using a transaction system to provide approval of an age-restricted transaction between an age presenter and an age verifier, the transaction system having a central database that has stored therein a biometric record associated with the age presenter via an age presenter identification code, the central database being configured to apply transaction rules, and at least one age verification station configured to access the central database, wherein the method comprises:
receiving, at the age verification station, a biometric sample proffered by the age presenter via a biometric identification device;
receiving, at the age verification station, an identification code proffered by the age presenter;
receiving, at the age verification station, transaction information;
sending the identification code proffered by the age presenter from the age verification station to the central database;
sending the transaction information from the age verification station to the central database;
comparing, at the central database, the proffered identification code to age presenter identification codes stored in the central database;
making, at the central database, a first determination whether the proffered identification code matches the age presenter code stored in the central database;
in the event the proffered identification code matches the age presenter code stored in the central database, making, at the central database, a second determination whether an age presenter age mapped to the biometric record corresponding to the age presenter code meets transaction rules;
in the event the at least one presenter age meets transaction rules, pre-approving, at the central database, the biometric record as a potential matching biometric record for age verification approval at the age verification station;
receiving, at the age verification station, the potential matching biometric record from the central database;
comparing, at the age verification station, the proffered biometric sample to the potential matching biometric record received from the central database;
making, at the age verification station, a third determination of whether the proffered biometric sample matches the potential matching biometric record;
in the event that the proffered biometric sample matches the at least one potential matching biometric record, making, at the age verification station, a fourth determination of whether the matching biometric record was pre-approved at the central database; and
in the event the matching biometric record was pre-approved at the central database, approving, at the age verification station, the transaction.

24. The method of using a transaction system as claimed in claim 23, wherein the method further comprises:
the age verification station sending to the central database confirmation of completion of the transaction.

25. The method of using a transaction system as claimed in claim 23, wherein the age presenter identification code comprises one or more of: a unique number, a reasonably unique number, and a non unique number.

26. The method of using a transaction system as claimed in claim 23, wherein the biometric sample comprises one or more of: a fingerprint, an iris scan, a facial scan, a voice scan, a retinal scan, a hand architecture scan, a vein pattern scan, a signature sample, and a DNA sample.

27. The method of using a transaction system as claimed in claim 23, wherein transaction data is encrypted and the communications between the age verification station and the central database are encrypted.

28. The method of using a transaction system as claimed in claim 23, wherein the transaction information comprises at least one alphanumeric code indicating at the central database the transaction rules to apply to the transaction.

29. The method of using a transaction system as claimed in claim 28, wherein transaction information further comprises one or more of: a terminal identification number associated with an age verification station, age verification station location, and the time of the transaction.

30. The method of using a transaction system as claimed in claim 23, wherein the age verification station is located at a location selected from the group consisting of: a verifier, a kiosk, an ATM, a telephone, a self-checkout POS register station, an automated cash register, a computer, a wireless device, and a vending machine.

31. The method of using a transaction system as claimed in claim 23, wherein the age-restricted transaction comprises a financial transaction.

32. The method of using a transaction system as claimed in claim 31, wherein financial transaction settlement is conducted via a financial transaction system comprising biometric authentication of payors.

33. The method of using a transaction system as claimed in claim 23, wherein system user information is stored in more than one database.

34. The method of using a transaction system as claimed in claim 33, wherein the transaction information is compared to information stored in more than one database.

35. A method of using a transaction system to provide approval of an age-restricted transaction between an age presenter and an age verifier, the transaction system having a central database that has stored therein a biometric record associated with the age presenter through an age presenter identification code, the central database being adapted to apply central transaction rules and to apply verifier transaction rules, and at least one age verification station configured to access the central database, wherein the method comprises:
receiving, at the age verification station, a biometric sample proffered by the age presenter via a biometric identification device;
receiving, at the age verification station, an identification code proffered by the age presenter;
receiving, at the age verification station, transaction information;
sending the biometric sample proffered by the age presenter from the age verification station to the central database;
sending the identification code proffered by the age presenter from the age verification station to the central database;
sending the transaction information from the age verification station to the central database;
comparing, at the central database, the proffered identification code to age presenter identification codes stored in the central database;
making, at the central database, a first determination whether the proffered identification code matches an age presenter code stored in the central database;
in the event the proffered identification code matches an age presenter code stored in the central database, making, at the central database, a second determination whether the proffered biometric sample matches an age presenter biometric record stored in the central database;
in the event the proffered biometric sample matches an age presenter biometric record stored in the central database, making, at the central database, a third determination whether an age presenter information record mapped to the matching presenter biometric record meets the verifier transaction rules;
in the event the age presenter information record mapped to the matching presenter biometric record meets the verifier transaction rules, making, at the central database, a fourth determination whether the age information mapped to said biometric record meets the central transaction rules;
in the event the age information mapped to said biometric record meets the central transaction rules, approving, at the database, the transaction; and
receiving at the age verification station confirmation of the transaction approval.

36. The method of using a transaction system as claimed in claim 35, wherein the age presenter identification code comprises one or more of: a unique number, a reasonably unique number, and a non unique number.

37. The method of using a transaction system as claimed in claim 35, wherein the biometric sample comprises one or more of: a fingerprint, an iris scan, a facial scan, a voice scan, a retinal scan, a hand architecture scan, a vein pattern scan, a signature sample, and a DNA sample.

38. The method of using a transaction system as claimed in claim 35, wherein the transaction data is encrypted and the communications between the age verification station and the central database are encrypted.

39. The method of using a transaction system as claimed in claim 35, wherein the transaction information comprises at least one alphanumeric code indicating at the central database the transaction rules to apply to the transaction.

40. The method of using a transaction system as claimed in claim 39, wherein transaction information further comprises one or more of: a terminal identification number associated with an age verification station, the age verification station location, and the time of the transaction.

41. The method of using a transaction system as claimed in claim 35, wherein the age verification station is located at a location selected from the group consisting of: a verifier, a kiosk, an ATM, a telephone, a self-checkout POS register station, an automated cash register, a computer, a wireless device, and a vending machine.

42. The method of using a transaction system as claimed in claim 35, wherein the age-restricted transaction comprises a financial transaction.

43. The method of using a transaction system as claimed in claim 35, wherein financial transaction settlement is conducted via a financial transaction system comprising biometric authorization of payors.

44. The method of using a transaction system as claimed in claim 35, wherein system user information is stored in more than one database.

45. The method of using a transaction system as claimed in claim 44, wherein the transaction information is compared to information stored in more than one database.

46. A method of using a transaction system to provide approval of an age-restricted transaction between an age presenter and an age verifier, the transaction system having a central database that has stored therein a biometric record associated with the age presenter, the central database being configured to apply transaction rules, and at least one age verification station configured to access the central database, wherein the method comprises:
receiving, at the age verification station, a biometric sample proffered by the age presenter via a biometric identification device;
receiving, at the age verification station, transaction information;
sending the biometric sample proffered by the age presenter from the age verification station to the central database;
sending the transaction information from the age verification station to the central database;
comparing, at the central database, the proffered biometric sample to age presenter biometric records stored in the central database;
making, at the central database, a first determination whether the proffered biometric sample matches any age presenter biometric record stored in the central database;
in the event the proffered biometric sample matches an age presenter biometric record stored in the central database, making a second determination whether the age information mapped to the biometric record meets transaction rules;
in the event the age information mapped to the biometric record meets transaction rules, approving, at the central database, the transaction; and
receiving at the age verification station confirmation of the transaction approval.

47. The method of using a transaction system as claimed in claim 46, wherein the biometric sample comprises one or more of: a fingerprint scan, an iris scan, a facial scan, a voice scan, a retinal scan, a hand architecture scan, a vein pattern scan, a signature sample, and a DNA sample.

48. The method of using a transaction system as claimed in claim 46, wherein the transaction data is encrypted and the communications between the age verification station and the central database are encrypted.

49. The method of using a transaction system as claimed in claim 46, wherein the transaction information comprises at least one alphanumeric code indicating at the central database the transaction rules to apply to the transaction.

50. The method of using a transaction system as claimed in claim 46, wherein the age approval station is located at a location selected from the group consisting of: a verifier, a kiosk, an ATM, a telephone, a self-checkout POS register station, an automated cash register, a computer, a wireless device, and a vending machine.

51. The method of using a transaction system as claimed in claim 46, wherein system user information is stored in more than one database.

52. The method of using a transaction system as claimed in claim 51, wherein the transaction information is compared to information stored in more than one database.

53. The method of using a transaction system as claimed in claim 46, wherein the age-restricted transaction comprises a financial transaction.

54. The method of using a transaction system as claimed in claim 53, wherein financial transaction settlement is conducted via a financial transaction system comprising biometric authorization of payors.

55. A method of using a transaction system to provide approval of an age-restricted transaction between an age presenter and an age verifier, the transaction system having a central database that has stored therein a biometric record associated with the age presenter via an age presenter identification code, and at least one age verification station configured to access the central database, the age verification station being configured to apply transaction rules, wherein the method comprises:
receiving, at the age verification station, a biometric sample proffered by the age presenter via a biometric identification device;
receiving, at the age verification station, an identification code proffered by the age presenter;
receiving, at the age verification station, transaction information;
sending the identification code proffered by the age presenter from the age verification station to the central database;
sending the transaction information from the age verification station to the central database;
comparing, at the central database, the proffered identification code to one or more age presenter identification codes stored in the central database;
making, at the central database, a first determination whether the proffered identification code matches any age presenter identification codes stored in the central database;
in the event the proffered identification code matches at least one age presenter code stored in the central database, sending to the age verification station as one or more potential matching biometric records the one or more biometric records corresponding to any matched age presenter codes;
sending to the age verification station one or more presenter ages that correspond to the one or more potential matching biometric records;
receiving, at the age verification station, the one or more potential matching biometric records sent from the central database;
receiving, at the age verification station, the one or more presenter ages mapped to the one or more potential matching biometric records sent from the central database;
making, at the age verification station, a second determination of whether the proffered biometric sample matches any of the one or more potential matching biometric records;
in the event that the proffered biometric sample matches any of the one or more potential matching biometric records, making, at the age verification station, a third determination whether a presenter age mapped to a matched biometric record meets the transaction rules; and in the event the presenter age mapped to the matched biometric record meets transaction rules, providing, at the age verification station, approval of the age-restricted transaction.

56. The method of using a transaction system as claimed in claim 55, wherein the age presenter identification code comprises one or more of: a unique number, a reasonably unique number, and a non unique number.

57. The method of using a transaction system as claimed in claim 55, wherein the biometric sample comprises one of: a fingerprint scan, an iris scan, a facial scan, a voice scan, a retinal scan, a hand architecture scan, a vein pattern scan, a signature sample, and a DNA sample.

58. The method of using a transaction system as claimed in claim 55, wherein the transaction data is encrypted and the communications between the age verification station and the at least one database are encrypted.

59. The method of using a transaction system as claimed in claim 55, wherein the age station is located at a location selected from the group consisting of: a verifier, a kiosk, an ATM, a telephone, a self-checkout POS register station, an automated cash register, a computer, a wireless device, and a vending machine.

60. The method of using a transaction system as claimed in claim 55, wherein system user information is stored in more than one database.

61. The method of using a transaction system as claimed in claim 55, wherein transaction information is compared to information stored in more than one database.

62. The method of using a transaction system as claimed in claim 55, wherein the age-restricted transaction comprises a financial transaction.

63. The method of using a transaction system as claimed in claim 62, wherein financial transaction settlement is conducted via a financial transaction system comprising biometric authorization of payors.

64. A method for authorizing a system user to use a transaction system, the transaction system having at least one database that receives and stores therein enrollment data associated with authorized system users through a system identification code, the method comprising:
prompting a prospective system user to proffer enrollment data comprising age information, personal information, a system identification code, and one or more biometric samples;
prompting a system operator to proffer verification of the enrollment data the prospective system user proffers;
transmitting to at least one database the proffered enrollment data;
transmitting to at least one database the proffered verifier verification of the proffered enrollment data; and
storing in the at least one database the proffered enrollment data and proffered verifier verification.

65. The method for authorizing a system user to use a transaction system according to claim 64, wherein the age information comprises one or more of: driver's license data, passport data, birth certificate data, and credit data.

66. The method for authorizing a system user to use a transaction system according to claim 64, wherein the personal information comprises one or more of: driver's license data, social security number, address, and phone number.

67. The method for authorizing a system user to use a transaction system according to claim 64, wherein the personal information is acquired via a process selected from the group consisting of: swiping, scanning, and hand-keying.

68. The method for authorizing a system user to use a transaction system according to claim 64, wherein the proffered biometric sample is entered via a biometric scanner.

69. The method for authorizing a system user to use a transaction system according to claim 64, wherein the prospective user proffers enrollment data at a location selected from the group consisting of: a verifier's station, a merchant's store, a kiosk, a self-checkout POS register station, and at a government office.

70. The method for authorizing a system user to use a transaction system according to claim 64, wherein the age presenter identification code comprises one of: a unique number, a reasonably unique number, and a non unique number.

71. The method of using a transaction system as claimed in claim 64, wherein the biometric sample comprises one of: a fingerprint, an iris scan, a facial scan, a voice scan, a retinal scan, and a hand architecture scan.

72. The method for authorizing a system user to use a transaction system according to claim 64, wherein saving the proffered enrollment data in at least one database comprises:
converting a biometric sample into a biometric template; and
saving the biometric template to at least one database in association with the system identification code.

73. The method for authorizing a system user to use a transaction system according to claim 72, wherein proffered enrollment data further comprises a record maintenance password.

74. The method for authorizing a system user to use a transaction system according to claim 73, wherein said a record maintenance password allows a system user to access a system user record to change system user information.

75. The method for authorizing a system user to use a transaction system according to claim 64, wherein the method further comprises:
in the event the proffered system identification code matches a system identification stored in at least one database, sending to the prospective system user one or more suggested system identification codes; and
receiving from the prospective system user a system identification code selected from the one or more suggested system identification codes.

76. The method for authorizing a system user to use a transaction system according to claim 64, wherein the method further comprises:
in the event the proffered system identification code matches a system identification stored in at least one database, assigning the prospective user an alternate system identification code.

77. The method for authorizing a system user to use a transaction system according to claim 64, wherein the proffered enrollment data further comprises a digital image of the biometric sample.

78. The method for authorizing a system user to use a transaction system according to claim 64, wherein the proffered enrollment data further comprises a digital image of the at least one document presented for system user identification or system user age verification.

79. The method for authorizing a system user to use a transaction system according to claim 64, wherein the proffered enrollment data further comprises financial account information.

80. The method for authorizing a system user to use a transaction system according to claim 64, wherein system user information is stored in more than one database.

81. A method for authorizing a system user to use a transaction system, the transaction system having at least one database that receives and stores therein enrollment data associated with authorized system users through a system user biometric record, the method comprising:
prompting a prospective system user to proffer enrollment data comprising age information, personal information, and one or more biometric sample;
prompting a system operator to proffer verification of the enrollment data the prospective system user proffers;
transmitting to at least one database the proffered enrollment data;
transmitting to at least one database the proffered verifier verification of the proffered enrollment data; and
storing in at least one database the proffered enrollment data and proffered verifier verification.

82. The method for authorizing a system user to use a transaction system according to claim 81, wherein the age information comprises one or more of: driver's license data, passport data, birth certificate data, and credit data.

83. The method for authorizing a system user to use a transaction system according to claim 81, wherein the personal information comprises one or more of: driver's license data, social security number, address, and phone number.

84. The method for authorizing a system user to use a transaction system according to claim 81, wherein the personal information is acquired via a process selected from the group consisting of: swiping, scanning, and hand-keying.

85. The method for authorizing a system user to use a transaction system according to claim 81, wherein the proffered biometric sample is entered via a biometric scanner.

86. The method for authorizing a system user to use a transaction system according to claim 81, wherein the prospective user proffers enrollment data at a location selected from the group consisting of: a verifier's station, a merchant's store, a kiosk, a self-checkout POS register station, and at a government office.

87. The method for authorizing a system user to use a transaction system according to claim 81, wherein the biometric sample is selected from the group consisting of: a fingerprint, an iris scan, a facial scan, a voice scan, a retinal scan, and a hand architecture scan.

88. The method for authorizing a system user to use a transaction system according to claim 81, wherein saving the proffered enrollment data in at least one database comprises:
converting a biometric sample into a biometric template; and
saving the biometric template to at least one database in association with the system identification code.

89. The method for authorizing a system user to use a transaction system according to claim 81, wherein the proffered enrollment data further comprises an account maintenance password.

90. The method for authorizing a system user to use a transaction system according to claim 81, wherein the proffered enrollment data further comprises a digital image of the biometric sample.

91. The method for authorizing a system user to use a transaction system according to claim 81, wherein the proffered enrollment data further comprises a digital image of the at least one document presented for system user identification or system user age verification.

92. The method for authorizing a system user to use a transaction system according to claim 81, wherein the proffered enrollment data further comprises financial account information.

93. The method for authorizing a system user to use a transaction system according to claim 81, wherein system user information is stored in more than one database.
